(19) United States
(12) Patent Application Publication
(10) Pub. No.: US 2002/0011008 A1
(43) Pub. Date: Jan. 31, 2002

(54) Linear measurement workpiece gripping device

(76) Inventors: Mark Nelson, Eagle Point, OR (US); Thomas G. Simcoe, White City, OR (US)

Correspondence Address: Kolisch, Hartwell, Dickinson,, McCormack & Heuser, 200 Pacific Building, 520 S.W. Yamhill Street, Portland, OR, 97204, US

(21) Appl. No.: 09/810,084

(22) Filed: Mar. 16, 2001

Related U.S. Application Data
(60) Provisional application No. 60/221,290, filed on Jul. 27, 2000.

(51) Int. Cl. G01B 3/10

(52) U.S. Cl. 33/770; 33/758

(57) ABSTRACT

A device attachable either removably or permanently, or installed as original equipment, on the outer free end of an otherwise conventional measuring tape for enhancing the ability of the outer end of the tape to grip and stay in place on the far side of a workpiece being measured. The device features a generally planar body expanse having perimeter structure disposed outwardly of the long axis of an associated measuring tape, with this perimeter structure being formed with a line-like array (curved or straight, and with or without corners) of tooth-like projection elements which are intended to face and engage and grip a surface in a workpiece being measured.

### CROSS REFERENCE TO RELATED APPLICATION

This application claims priority to Provisional Application Ser. No. 60/221,290 filed Jul. 27, 2000 titled “Linear Measurement Workpiece Gripping Device” which is hereby incorporated by reference.

### BACKGROUND OF THE INVENTION

This invention pertains to a device which is usable on the outer end of an otherwise conventional extensible tape measure. Specifically, it relates to such a device generally which, furnishes a special kind of workpiece-gripping surface that eases the use of tape measures by a single person under circumstances where the length of measurement being performed causes the user to be out of reach of the outer end of the tape, and under well-known circumstances where the typical outer tape end can unexpectedly slip away from engagement with the workpiece that is being measured.

With reference to the field in which this invention takes its place, those familiar with wood construction projects of various kinds know that, with respect to a conventional kind of tape measure, it is common that, on the free end of that measure, there is a small, generally L-shaped end piece which has an orthogonally extending short leg that is intended to catch onto the end or edge of a workpiece during a measurement procedure. Such an end piece functions to enable a single person, normally fairly easily, to perform relatively long-distance measurements hopefully without the need for second-party assistance. Often, however, the workpiece-contacting end pieces on conventional tape measures do not have any kind of special frictioning, or roughened, gripping surfaces, and as a consequence, they are often not very sure-footed in terms of staying in place during a “single-handed” measurement procedure. Accordingly, and often somewhat inconveniently, and particularly where a relatively long length of material is to be measured with a tape measure, it is usually the case that two people are actually required in order to stabilize a measuring tape's outer end.

In this setting, proposed by the present invention are several varieties of attachable (removably or permanently), roughened-surface gripping devices that can be secured either directly to the end of a conventional measuring tape, or to the kind of L-shaped end piece mentioned above. A preferred embodiment of this invention is described hereinbelow in conjunction with a device which can be snapped into place on a completely conventional tape measure, and in particular, can be snapped in place in a fashion which, if so desired, allows it easily to be removed if desired.

The device of the present invention, generally speaking, is formed with what is referred to herein as a gripper body. This body has a generally planar body expanse which includes perimeter structure that extends, depending upon the particular embodiment involved, in different manners along the perimeter of the body expanse. The perimeter structure is formed with plural and spaced, distributed workpiece-gripping projection elements, such as bumps or teeth.

Also included in the gripping device of this invention, and working cooperatively with the body expanse, is a mounting structure that is joined to that body expanse, which mounting structure accommodates mounting of the device on a tape measure at the location adjacent the tape's outer end. Specifically, this mounting structure mounts the overall gripping device in such a manner that different ones of the workpiece-gripping projection elements face the gripping surface of a workpiece to be measured. In some instances, the perimeter structure with projection elements is designed in such a fashion that the perimeter projection elements effectively are distributed on opposite sides of what can be thought of as the nominal plane of the tape in the tape measure. Preferably, the perimeter's projection elements are distributed in a circumsurrounding fashion relative to the long axis of the tape. In a preferred embodiment of the invention, these elements are distributed generally along a circular “linear” perimeter path followed and defined by the device's perimeter structure. In other embodiments, projection elements are distributed in other manners, including being distributed in relatively short stretches that are located toward the opposite edges of a tape measure when the device is in place on the outer end of such a measure. The last-mentioned embodiment is illustrated and described hereinbelow and can be thought of as having a kind of butterfly distribution for its projection elements as such elements are viewed nominally along the long axis of the associated, attached-to tape measure.

In the description of various embodiments, including a preferred embodiment of the present invention hereinbelow, structural features of the various device embodiments that are essentially common to all of the devices, and present in accordance with this invention, are designated with similar reference characters (numerals and/or letters). Where differences exist between different modifications, appropriate differentiating reference numerals and/or letters are employed.

In one interesting embodiment of the invention, the device, according to that embodiment, while being equipped certainly with projection elements of the type generally mentioned above, is also constructed to receive, removably, an attachable cushioning/high-frictioning pad-like element. This element can be employed under circumstances where a measurement is to be made relative to the surface of a piece of wood with respect to which one needs to guard against marring, scratching, etc. of that surface. This removable frictioning/cushioning-type element allows the user to draw the tape under tension in a fashion whereby that cushioning element, along with the tiny tip regions of projection elements, form a sure grip which is essentially a non-marring grip.

As will also be apparent from the description which follows below, and in conjunction with the several pages of accompanying drawings herein, it will be apparent that the device of this invention can be made in a number of different configurations, all of which contain essentially the core common elements of the invention that make it so useful in relation to sure-footed, single-handed use of a measuring tape.

The various objects and advantages which are offered by the present invention, some of which have just been suggested, will become more fully apparent as the description which now follows is read in conjunction with the accompanying drawings.

### DESCRIPTION OF THE DRAWINGS

FIG. 1 is a fragmentary side elevation of the outer end of a conventional measuring tape which includes a generally L-shaped end piece normally found on such a tape end.

FIG. 2 is a fragmentary perspective view of the same tape shown in FIG. 1, with dash-double-dot lines illustrating an orate/circular outline that represents generally the location of a preferred embodiment of the present workpiece-gripping invention when it is in a condition attached to the outer end of the tape element in that tape.

FIG. 3 is somewhat like FIG. 2, except that here a preferred embodiment of the invention is shown attached to the tape structure.

FIG. 4 is a view taken generally from the far side of FIG. 3, somewhat in perspective, illustrating a view of that side of the device of the invention shown in FIG. 3 in a condition nonattached to a tape element.

FIG. 5 is a view stylized to picture the generally planar circular body, and a face in that body, in the workpiece-gripping device of FIGS. 3 and 4. This device oriented with projection elements in the device facing the viewer in FIG. 5, and shown to be distributed in a circumsurrounding fashion along a generally circular linear path which circumsurrounds the long axis of such a tape element. In FIG. 5, central structure which is utilized as will be explained to snap this device into place on the tape element in a tape measure is omitted from the view. Dash-dot lines are employed, along with angular indicators, to represent two modified forms of invention structure wherein, essentially, projection elements that form the gripping components of the device are arrayed either in what was referred to earlier as a kind of butterfly arrangement on diametrically opposite sides of the planar circular body in the device, or on one semicircular portion only of rim structure in the device.

FIG. 6 is a cross-sectional view taken generally along the line 6-6 in FIG. 5, showing central portions of the planar body portion formed with a punch-shifted central ribbon, or tab, and slot structure that function to enable attachment, removable or nonremovable selectively, of this device to a conventional tape measure, such as the tape measure shown in FIGS. 1 and 2.

FIG. 7 is a fragmentary side elevation illustrating the workpiece gripping device of FIGS. 3-6, inclusive, fully installed on the end device in a measuring tape such as the one pictured in FIGS. 1 and 2, all illustrated in an operative condition relative to making a measurement on and along a fragmentarily shown workpiece.

FIG. 8 is a fragmentary schematic view stylized to illustrate a performance feature of the device of FIGS. 3-7, inclusive, and specifically showing a region of small-area nearly point-contact gripping that characterizes operation of the device in a manner which will be discussed below.

FIG. 9 is a fragmentary schematic view in a stylized fashion illustrating a modified form of device wherein perimeter structure is angular and polygonal with projection tooth-like elements extending in straight linear stretches that intersect at angles to form corners.

FIG. 10 is a view much like FIG. 8, but showing specifically the contact performance feature that characterizes, here, the modified structure of FIG. 9.

FIGS. 11 and 12 illustrate another modified form of a workpiece-gripping device constructed in accordance with the invention.

FIG. 13 illustrates still another modified form of the invention wherein the device includes a generally planar body portion which is rectangular in outline.

FIGS. 14 and 15 illustrate yet a further modified form of workpiece gripping device constructed in accordance with the present invention, here showing a kind of book-fold device which can be snap fit onto one conventional style of a tape-end device in a conventional tape measure.

FIGS. 16 and 17, and 18 and 19, show two further kinds of modified versions of a workpiece gripping device that has been constructed incorporating the features of the present invention. The device pictured in FIGS. 16 and 17 is designed for permanent attachment in a fixed position on the outer end of a tape element in a conventional measuring tape, and the device shown in FIGS. 18 and 19 is adapted for attachment to such a tape element outer end for swiveling about an axis which is generally normal to the nominal plane of that tape element.

FIGS. 20-22, inclusive, illustrate still a further embodiment of the invention which is designed to employ, according to this invention, a frictioning/cushioning pad generally of the type mentioned briefly earlier herein. In FIG. 20, such a pad is shown in a not yet attached condition. In FIG. 21, attachment has taken place, and in FIG. 22, not only has attachment taken place, but the entire assembly of the device of the invention and the outer end of the conventional measuring tape are shown in relation to performing a measurement in conjunction with a workpiece which is shown fragmentarily in FIG. 22.

FIG. 23 shows one additional modification of a workpiece gripping device constructed in accordance with the present invention, and specifically another form of device which, like the device pictured in FIGS. 16 and 17, is designed for, and in FIG. 23 is, attached permanently to the outer end of the tape element in a conventional measuring tape.

### DETAILED DESCRIPTION OF, AND BEST MODE FOR CARRYING OUT, THE INVENTION

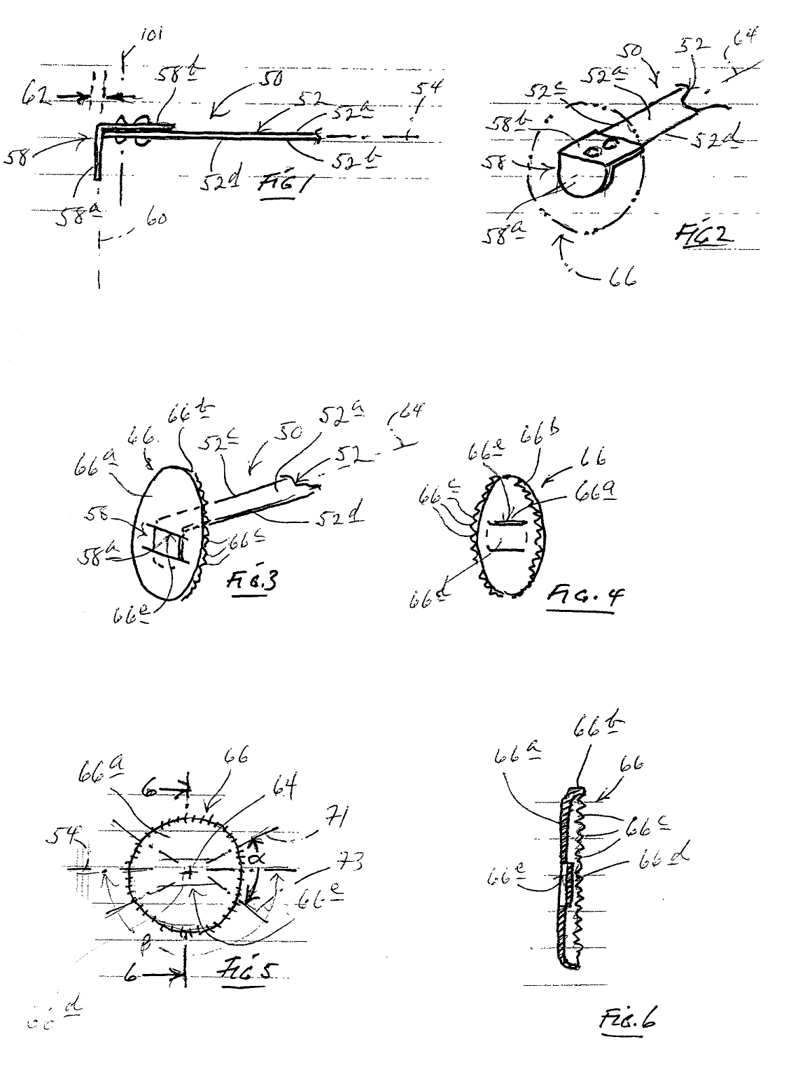

Turning attention now to the drawings, and referring first of all to FIGS. 1-6, inclusive, indicated fragmentarily and generally at 50 in FIGS. 1, 2 and 3, is the outer end of a conventional elongate measuring tape. Included in this tape is the usual elongate measuring tape element 52 having a measurement indicia side 52a, a non-indicia side 52b, and lateral edges 52c, 52d. Tape element 52 can be thought of as having, or as generally occupying, at least in the extended condition shown fragmentarily in FIGS. 1, 2 and 3, a nominal plane which, in FIG. 1, is shown at 54.

Mounted by suitable and conventional attaching structure 56, adjacent the outer end (the left end in FIGS. 1, 2 and 3) of tape element 52, is a right-angular tape end device 58 which includes a downturned lateral projection 58a that generally occupies a plane 60 which is approximately at a right angle relative to the part 58b of this end device which is directly secured to the outer end of the tape element. Plane 60 is generally at a right angle relative to previously-mentioned plane 54. In most conventional measuring tapes of the type now generally being described and illustrated, the end device is permitted a certain amount of back and forth, confined, translational motion, and such is indicated by arrows 62 in FIG. 1. This play in the actual position which the end device assumes relative to the outer end of the tape element accommodates use of the tape for measuring distances either from an outside or inside surface of workpiece, as is well recognized and understood in the practice of using such tapes.

It is to solve the difficulty encountered many times and by many users of such tape measuring devices, involving the propensity of the downturned portion 58a in device 58 to slip away from the far surface of a workpiece whose length, or along whose length, that the present invention steps in with a resolution. This kind of problem often arises where the person using the tape is making a measurement which is well out of arm's reach of the position of element 58 under conditions with the tape extended so as to make the required measurement. It can come about from a number of instability inducing factors, such as slight translational and/or rotational and/or angular motion that occurs in the tape as the same is being drawn to full extension and positioned properly. The consequence, of course, is that the end slips away frequently, and the measurement cannot be made until the tape is stabilized. Often the only way to stabilize a tape turns out to be to require the presence of another person to hold this outer end of the tape securely in place until the measurement is made.

Looking especially now at FIGS. 2-6, inclusive, FIG. 2, wherein there is presented a somewhat ovate/circular dash-double-dot line, helps to illustrate generally the environmental location and positioning of the preferred embodiment of this invention when it is mounted in place on the outer end of the tape measure, and specifically mounted herein on the downturned lateral extension 58a in end device 58. In this setting, one can see that the device of this invention, in such a position, generally has a perimeter which circumsurrounds the long axis of tape element 52, which long axis is shown at 64 in FIGS. 2, 3 and 5. As will become apparent shortly, the specific embodiment of the present invention now being described, when generally in place (as suggested by the dash-double-dot lines in FIG. 2) on the outer end of tape 50, is disposed to be capable of securely gripping the far side surface in a workpiece, almost no matter what the modest rotational orientation is of tape element 52.

FIGS. 3-6, inclusive, illustrate specifically certain details of the preferred embodiment of the device of this invention. This device, designed 66, generally has a kind of bottle-cap configuration. Device 66 is referred to herein as a workpiece-gripping device.

Looking specifically at several structural features of device 66, the same includes a generally planar, circular body, or body expanse, 66a whose perimeter is formed with an angularly disposed, generally continuous, annular rim structure 66b, also referred to as a perimeter structure. Perimeter structure 66b circumsurrounds previously-mentioned tape-element axis 64, and includes a linear/arcuate array, or line, -like arrangement of tooth-like projection elements 66c. Elements 66a are also referred to herein as being arranged in a line-following, long-path array. With device 66 in place, and here referring especially to FIG. 3, one can see that the device is positioned in such a fashion that the teeth, or projection elements, 66c are aimed inwardly toward tape element 52. Thus, they are appropriately oriented for gripping the far surface of a workpiece that is to be measured using the combination of tape 50 and device 66. FIG. 7 is now referred to as an illustration of this operational/use condition, wherein a measurement procedure is illustrated in relation to workpiece 67.

Formed in any suitable fashion, and generally centrally within, body expanse 66a is a punched-out, elongate ribbon 66d (see particularly FIGS. 4, 5 and 6) which has been punched to displace it from the plane of expanse 66a, and in a direction which is toward the direction that teeth 66c point. This ribbon forms, with remaining portions of the body expanse, a channel 66e which is adapted to receive the downturned lateral extension 58a in end device 58 in tape 50. The exact configurations of ribbon 66d and channel 66e (collectively a mounting structure) can take on various selectable shapes and configurations, depending upon the exact structure of the particular kind of tape measure with respect to which the device of this invention is intended to be used. Preferably, this mounting structure is designed in such a fashion that the downturned end of a tape end device with which the device of the invention is to be used, can receive a component, such as component 58a, in a snap-fit kind of fashion. FIGS. 3 and 7 illustrate such an attached condition for device 66 on tape 50.

It will be clearly apparent that the exact way in which snap fitting occurs can be defined in a number of different ways. For example, snap fitting could be enabled in such a fashion that a device, like device 66, could easily be placed removably on the outer end structure of a measuring tape if so desired, or could be fitted there in such a fashion that, essentially, it is intended to be a permanently attached element. Further, it is entirely within the scope of this invention to include a device like device 66, made in accordance with this invention, which is formed in a rather permanent fashion on a measuring tape in the original fabrication of the tape. These different approaches for employing a device in accordance with the invention are simply and purely matters of user/designer choice.

From the description which has just been given, it will be clear that when device 66 is mounted in place as shown in FIGS. 3 and 7, a user of tape 50 can, without any requirement necessarily to use the assistance of another party, take a measurement, even a very long measurement, with the projection teeth in device 66 securely and confidently engaged with the far surface of the particular workpiece being measured. Very clearly, device 66, as so far described, takes the form of a very simple structure, which can easily be manufactured, can be quite inexpensive, and can readily be made to fit conveniently, and even removably if so desired, on the outer end structures of a whole host of different specific measuring-tape structures.

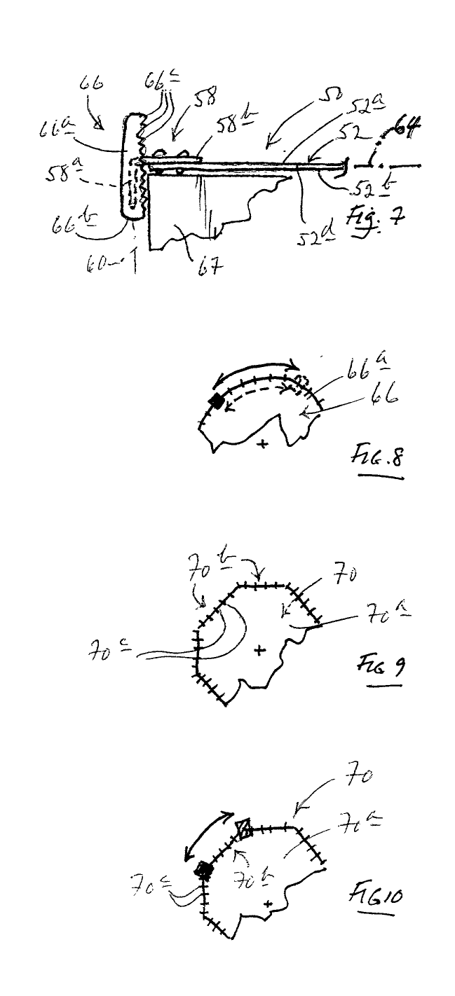

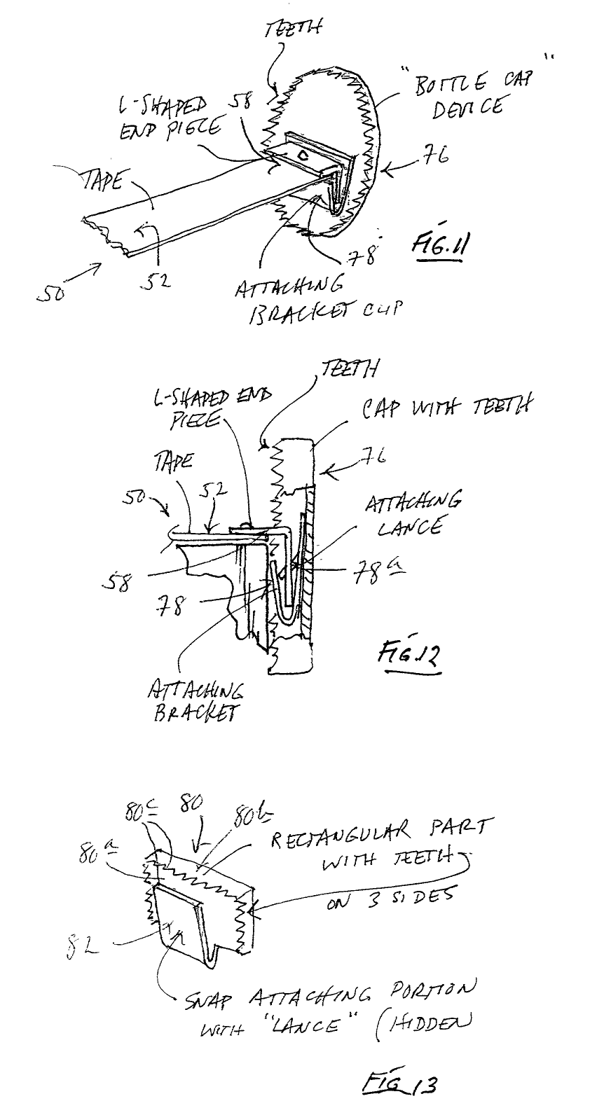

Focusing particular attention back for a moment now on FIG. 5, previously mentioned tape-element plane 54 is here shown, along with two other dash-dot lines 71, 73. These three dash-dot lines in FIG. 5 will now be employed to describe certain other modifications that can be made in a device like device 66. For example, one modified form of the invention is built in such a fashion that the rim, or perimeter, structure which contains the tooth-like gripping elements is disposed entirely to one side of plane 54, and specifically along the semi-circular lower side of the perimeter structure shown in FIG. 5. This semi-circular distribution for projection teeth is illustrated by angle β in FIG. 5.

Yet another modified form of the invention is one wherein there are two diametrally arranged linear arcs of projecting teeth, which arcs lie along the left and right sides of device 66 as such is pictured in FIG. 5. In particular, the arcs lie between lines 68, 70 which span the angle illustrated at α in FIG. 5. In this kind of arrangement, the projecting teeth are arranged in a kind of butterfly manner as such is pictured in FIG. 5. Such teeth are disposed, with the device in place on a measuring tape, on laterally opposite sides, or edges, of tape element 52.

Turning attention now to FIGS. 11 and 12, here, another modified form of a workpiece-gripping device constructed in accordance with this invention is illustrated. FIGS. 11 and 12 show a device 76 which in many respects is like device 66, at least in terms of the shape and configuration of the body expanse and the perimeter structure in the device. But here, a different mounting structure is employed in the device for enabling mounting of that device on the outer end structure of a tape, like tape 50. This mounting structure takes the form of a releasably locking clip structure 78 which has the configuration clearly illustrated in FIGS. 11 and 12, including a projecting lance structure 78a (see FIG. 12) which, with the device in place on a tape as is illustrated, extends lockingly through a central opening that exists in many conventional tape-measuring devices in the downturned portion of the outer end piece 58.

FIG. 13 shows a further modified form 80 of the invention, wherein a body expanse 80a is generally rectangular in form, with projecting teeth 80c in a perimeter structure 80b distributed in straight lines along three sides of that configuration, as is clearly seen in FIG. 13. This form of the invention is formed with a clip structure 82 which is very much like previously-described clip structure 78. Device 80 is appropriately sized in such a manner that the projecting teeth will assuredly grip the far surface of a workpiece.

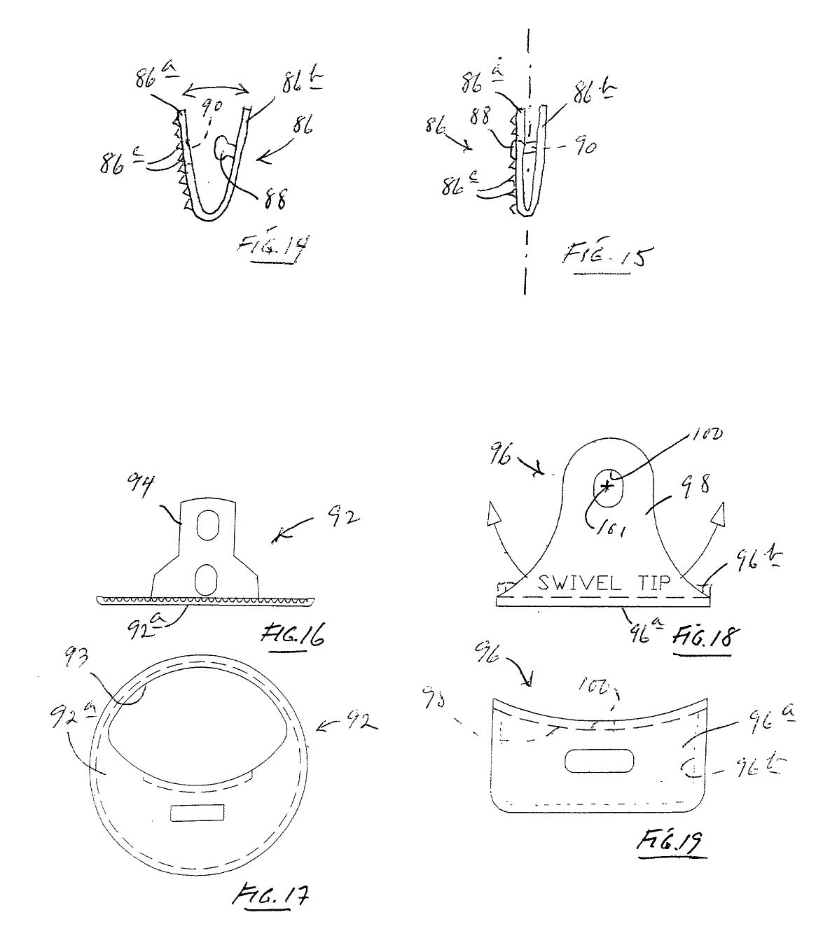

FIGS. 14 and 15 illustrate at 86 what might be thought of as a bookfold kind of device made in accordance with the invention. The part in device 86 which corresponds to a planar body expanse is shown at 86a and this expanse faces another roughly matching-outline expanse 86b. Distributed along the perimeter edge of expanse 86a is edge structure including tooth-like projections 86b. This distribution of workpiece-engaging projection elements has an arrangement which is very much like that pictured for the device in FIG. 13. In other words, device 86 has a somewhat rectangular shape like the device pictured in FIG. 13.

Suitably joined to and projecting to the left in FIGS. 14 and 15, from the left face of expanse 86b, is a latch button 88. This button is snap fittable, and reversibly so, through a latch hole 90 which is formed centrally in expanse 86a. In FIG. 14, device 86 is shown in a kind of open-book configuration, with the latch button not engaged with hole 90. In FIG. 15, the planar components of device 86 have been squeezed toward one another, and here, latch button 88 is shown having passed through and become caught by latch hole 90.

The device of FIGS. 14 and 15 is removably attached, when in use, to the downturned end of an endpiece in a tape measure of the kind which includes a central opening that allows for passage of latch button 88, with the “book flaps” (86a, 86b) of the device substantially jacketing opposite sides of the downturned portion of such an end device.

FIGS. 16 and 17 show a side elevation and a frontal view, respectively, of another modified form of a device 92 which is constructed according to the invention. device 92 includes a generally circular (with large opening 93) body expanse 92a having a perimeter structure which is somewhat like that present in the device of FIGS. 3-6, inclusive. Here, however, device 92 includes a projecting tab 94 which accommodates direct fixed mounting of this device onto the outer end of the tape component in the tape measure under circumstances where there is no endpiece like endpiece 58 previously described.

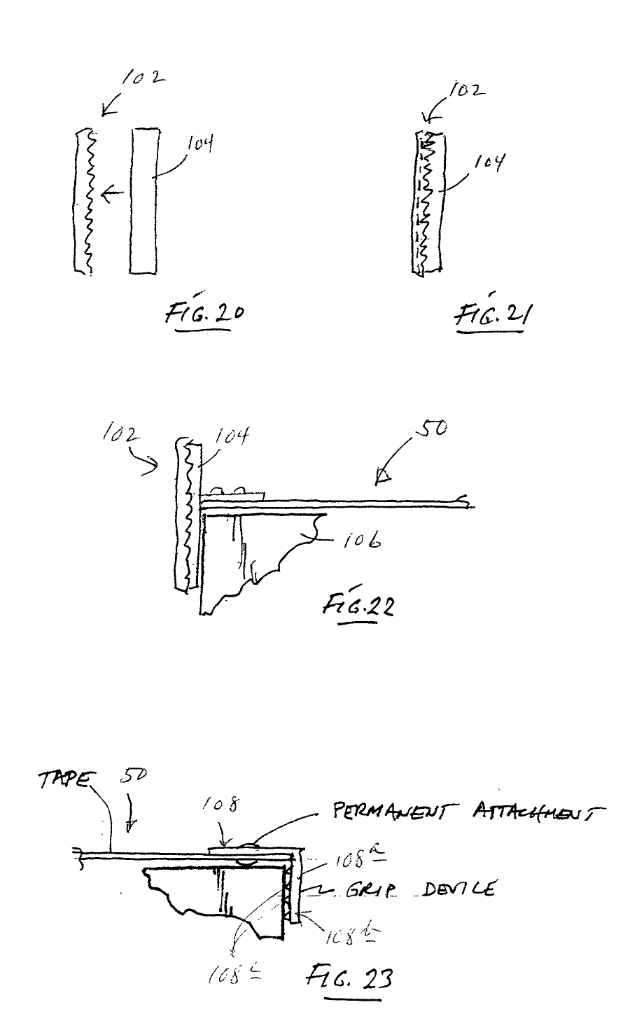

FIGS. 18 and 19 show still another modification 96 of a device built in accordance with this invention. Device 96 is constructed with a body expanse 96a having a tooth-projection perimeter structure 96b. Joined to expanse 96a at substantially a right angle is a mounting structure tab 98 furnished with a hole 100. Via this hole, device 96 is adapted for swivel mounting on the outer end of a tape element, and in particular for side-to-side swiveling about an axis such as the one shown at 101 in FIGS. 1 and 18. This axis, with the device in place on the outer end of a measuring tape, allows the body expanse 96a effectively to accommodate side-to-side angulation of the long axis of a tape element.

FIGS. 20-22, inclusive, as has already been mentioned briefly, illustrate a device 102 which very much like previously-described and described device 66. Details of construction of this device are not shown in FIGS. 20-22 inclusive, but it should be understood that those details are essentially the same as the ones that were described earlier in conjunction with device 66. In each of FIGS. 20, 21 and 22, the projecting tooth-like elements in device 102 face to the right in these figures. In device 102, or more particularly with respect to this device, provision is made for the selective removable insertion and withdrawal, into the shallow cavity formed by the body expanse and its perimeter structure, so as to receive a generally circular, appropriate-thickness frictioning/cushioning pad, such as the one shown at 104. In FIG. 20, components 102, 104 are detached from one another. In FIG. 21, they are shown attached, and in FIG. 22, they are shown not only attached to one another, but also effectively attached to the outer end device in an otherwise conventional tape measure which is shown at 50. A suitable central opening (not shown) is provided in unit 104 to accommodate attachment of device 102 to the end device in tape 50. FIG. 22 shows this modified form of the invention in use making a measurement along a workpiece 106, which workpiece has a surface finish that one wishes to avoid scratching or marring. As can be seen in FIG. 22, the frictioning/cushioning pad principally is the structure that engages a contact face in the workpiece, and this contact affords a good grip for the device, which grip may be enhanced by slight touching of the tip ends of the tooth-like projections with the workpiece. It will be clear how this arrangement can minimize the likelihood of scarring a workpiece's contact surface.

FIG. 23 illustrates still another device 108 constructed in accordance with the invention. Device 108 has a generally L-shaped configuration, as can be seen in FIG. 23, wherein a planar body portion 108a carries a distribution of linearly arranged tooth projections 108c in perimeter structure 108b. The upper portion of device 108 in FIG. 20 is shown in a condition of permanent attachment to the outer free end of tape 50.

It should thus be apparent that the device of the present invention, in all forms illustrated and described herein, can take a fairly large number of different specific forms to function effectively in different operational settings, and in conjunction with different kinds of mountings of the device on and adjacent the outer free ends of conventional tape measures. The specific structure in each of these devices includes a body expanse that is generally planar, a perimeter structure associated with that expanse in which are formed linear (circular or straight) arrays of tooth-like projections, and appropriate mounting structure.

It is desired to claim and secure by Letters Patent:

1. A workpiece-gripping device joinable adjacent the outer end of an elongate, ribbon-like and generally nominally planar linear measuring tape comprising
a gripper body having a generally planar body expanse with perimeter structure which generally circumsurrounds said body expanse, said perimeter structure being formed with plural, spaced, perimeter-distributed, workpiece-gripping projection elements, and
mounting structure joined to said body expanse, and accommodating mounting of the device on such a tape at a location adjacent the tape's outer end, and in such a manner that different workpiece-gripping projection elements that are present in said perimeter structure are operatively located on, and in spaced relation to, opposite sides of the tape's nominal plane, and with said elements generally extending toward the tape.

2. The device of claim 1, wherein said body expanse is generally circular, said perimeter structure is generally annular, and said projection elements are tooth-like in configuration.

3. The device of claim 1, wherein said body expanse has a perimeter structure which is generally polygonal, with plural, generally straight-linear rims that intersect at angles to form curves.

4. The device of claim 1 or 2 which is for use as a freely attachable object in relation to a conventional measuring-tape outer end structure of the kind having a lateral projection which extends one-sidedly, laterally and generally outwardly in a plane which is disposed at an angle relative to the plane of the tape per se, and said mounting structure takes the form of a snap-capture arrangement adapted to receive, and generally lock into a defined relative fixed positional relationship with respect to, such a projection.

5. The device of claim 4, wherein said snap-capture arrangement takes the form of a displaced ribbon portion of said body expanse, which cooperates with other parts of the body, forms a channel designed to receive such a tape's outer end's lateral projection.

6. The device of claim 4 which is characterized, as well, by free selective detachability relative to such a tape's outer end's lateral projection.

7. A workpiece-gripping device joinable adjacent the outer end of an elongate, ribbon-like and generally planar linear measuring tape comprising
a gripper body including plural, generally line-following, distributed workpiece-engaging projection elements arranged generally in a kind of two-dimensional, long-path array, and
mounting structure joined to said body and accommodating mounting of the device on such a tape at a location adjacent the tape's outer end, and in a condition wherein projection elements in the body generally extend toward the tape, and are distributed generally in a laterally circumsurrounding fashion relative to the tape's long axis, and whereby workpiece gripping during use of the measuring tape can take place generally and selectively in substantially all longitudinally circumsurrounding regions near the tape's outer end.

8. The device of claim 7, wherein said body expanse is generally circular, said perimeter structure is generally annular, and said projection elements are tooth-like in configuration.

9. The device of claim 7, wherein said body expanse has a perimeter structure which is generally polygonal with plural, generally straight-linear rims that intersect at angles to form curves.

10. The device of claim 7 or 8 which is for use as a freely attachable object in relation to a conventional measuring-tape outer end structure of the kind having a lateral projection which extends one-sidedly laterally and generally outwardly in a plane which is disposed at an angle relative to the plane of the tape per se, and said mounting structure takes the form of a snap-capture arrangement adapted to receive, and generally lock into a defined relative fixed positional relationship with respect to, such a projection.

11. The device of claim 10 which is characterized as well by free, selective detachability relative to such a tape's outer end's lateral projection.

12. A workpiece-gripping device removably joinable selectively adjacent the outer end of an elongate, ribbon-like, and generally planar linear measuring tape, said device comprising
a generally planar gripper body which is formed with plural, spaced, distributed, workpiece-gripping projection elements, and
snap-fit mounting structure joined to said body and adapted for fitting of the device onto such a tape, with the plane of the gripper body substantially paralleling the plane of the tape-end projection, and with said projection elements generally extending toward such a tape.

13. A tape-measuring device comprising
an elongate, ribbon-like and generally nominally planar measuring tape having an exposed free end, and
a workpiece gripping device joined to said tape adjacent the tape's said free end, said gripping device including
a gripper body having a generally planar body expanse with perimeter structure which generally circumsurrounds said body expanse, said perimeter structure being formed with plural, spaced, perimeter-distributed workpiece-gripping projection elements, and
mounting structure joined to said body expanse, and directly mounting said gripping device on said tape's free end in such a manner that different workpiece-gripping elements that are present in said perimeter structure are operatively located on, and in spaced relation to, opposite sides of the tape's nominal plane, with these elements generally extending toward said tape.

14. A workpiece-gripping device joinable adjacent the outer end of an elongate, ribbon-like and generally nominally planar, linear measuring tape, which tape includes a measurement-indicia side and a non-indicia side disposed on opposite sides of the tape's generally nominal plane, said device comprising
a gripper body including plural, generally arcuate, linearly distributed workpiece-engaging projection elements arranged generally in a kind of two-dimensional, long-path array, and
mounting structure joined to said body and accommodating mounting of the device as a whole on such a tape at a location adjacent the tape's outer end, and in a condition wherein the arcuate, linearly distributed projection elements generally extend toward the tape, and are deployed along a curved line which resides generally entirely on the non-indicia side of the tape relative to the tape's generally nominal plane.

15. A workpiece-gripping device joinable adjacent the outer end of an elongate, ribbon-like and generally nominally planar linear measuring tape, which tape includes lateral edges, and a measurement-indicia side, and a non-indicia side disposed on opposite sides of the tape's generally nominal plane and each extending between said lateral edges, said device comprising
a gripper body including plural, generally linearly distributed workpiece-engaging projection elements arranged generally in at least two, spaced, arcuate linear arrays, and
mounting structure joined to said body and accommodating mounting of the device as a whole on such a tape at a location adjacent the tape's outer end, and in a condition wherein at least two arcuate arrays of projection elements straddle the tape's generally nominal plane in two, laterally-spaced regions which are located near the tape's lateral edges, with said elements generally extending toward the tape.

16. A tape-measuring device comprising
an elongate, ribbon-like and generally nominally planar measuring tape having an exposed free end, and
a workpiece gripping device joined to said tape adjacent the tape's said free end, said gripping device including
a gripper body including plural, generally arcuate, linearly distributed, workpiece-engaging projection elements arranged generally in a kind of two-dimensional, long-path array, and
mounting structure joined to said body, and directly mounting said gripping device on said tape's free end in such a manner that different workpiece-engaging elements that are present in said long-path array are operatively located on, and in spaced relation to, opposite sides of the tape's nominal plane, with these elements generally extending toward the tape.

17. A workpiece-gripping device removably joinable selectively adjacent the outer end of an elongate, ribbon-like, and generally planar linear measuring tape of the kind having a lateral projection which extends one-sidedly, laterally and generally outwardly, in a plane which is disposed at an angle relative to the plane of the tape per se, said device comprising
a generally planar gripper body which is formed with plural, spaced, distributed, workpiece-gripping projection elements, and
snap-fit mounting structure joined to said body and adapted for removable snap-fitting of the device onto such a tape-end projection, with the plane of the gripper body substantially paralleling the plane of the tape-end projection, and with said projection elements generally extending toward such a tape.

18. The device of claim 17, wherein said mounting structure includes a swing tab that, with the device mounted on such a tape, accommodates swiveling of the device about an axis which is generally normal to the place of the tape.

19. The device of claim 17 which further includes a removable soft-surface attachment which is removably attachable to said body substantially to mask, at least partially, the presence of said elements, and to promote soft-surface engagement between the device and a workpiece.
